(19) United States
(12) Patent Application Publication
(10) Pub. No.: US 2020/0276776 A1
(43) Pub. Date: Sep. 3, 2020

(54) METHOD FOR REPAIRING A COMPOSITE PROFILE

(71) Applicant: Safran Nacelles, GONFREVILLE L'ORCHER (FR)

(72) Inventors: Nicolas DEZEUSTRE, GONFREVILLE L'ORCHER (FR); Frédéric AMBLARD, MOISSY-CRAMAYEL (FR)

(73) Assignee: Safran Nacelles, GONFREVILLE L'ORCHER (FR)

(21) Appl. No.: 16/876,783

(22) Filed: May 18, 2020

Related U.S. Application Data
(63) Continuation of application No. PCT/FR2018/052858, filed on Nov. 15, 2018.

(30) Foreign Application Priority Data
Nov. 16, 2017 (FR) 1760808

(51) Int. Cl. B29C 73/10

(52) U.S. Cl. CPC B29C 73/10

(57) ABSTRACT

A method for repairing a composite profile section having a fault includes processes that involve producing a composite repair part by placing a soft composite repair composition in a mold having a configuration that is identical to a corresponding configuration of the profile section to be repaired, or on an identical zone of the profile section to be repaired, hardening the repair composition, and affixing the repair part that is obtained onto the profile section including a fault.

### CROSS-REFERENCE TO RELATED APPLICATIONS

This application is a continuation of International Application No. PCT/FR2018/052858, filed on Nov. 15, 2018, which claims priority to and the benefit of FR 17/60808 filed on Nov. 16, 2017. The disclosures of the above applications are incorporated herein by reference.

### FIELD

The present disclosure relates to a method for repairing a composite profile including a defect.

### BACKGROUND

The statements in this section merely provide background information related to the present disclosure and may not constitute prior art.

It is known that in many fields, particularly in the automobile field or in the aeronautical field, it is increasingly frequent to produce patches made of composite material, generally by using a set of plies of a synthetic fabric impregnated with resin which is shaped then hardened.

When the profile has a defect, for example a tear, a repair patch is produced using the same technique, that is to say by depositing a set of plies of a fabric impregnated with resin on the area to be repaired then by hardening the resin.

Nonetheless, there are circumstances for which it is not possible to apply this type of repair. In practice, the repair patch is then produced in metal then affixed by bonding to the profile to be repaired.

However, a metal patch has a greater weight than a composite patch. Furthermore, the metal patches have a higher stiffness than the composite patches of corresponding shape, and their shaping is more difficult. In addition, metal patches cannot be simply bonded, but must be riveted. Therefore, current repair solutions are not satisfactory.

### SUMMARY

This section provides a general summary of the disclosure and is not a comprehensive disclosure of its full scope or all of its features.

The present disclosure provides a method for repairing a composite profile while reducing the impact of the repair on the technical characteristics of the concerned profile.

A method for repairing a composite profile including a defect is provided according to the present disclosure. The method comprises producing a composite repair patch by disposing a soft (uncured) composite repair composition in a mold having a configuration substantially identical to the configuration of the profile to be repaired, or on an identical area of the profile to be repaired, hardening the repair composition, and affixing the composite repair patch obtained on the patch including a defect.

Thus, the production of the composite repair patch with a soft composite repair composition allows performing this production in an improved way, and the rigidity of the obtained patch allows affixing of the composite repair patch.

According to an advantageous version of the present disclosure, the repair composition comprises plies of a fabric of synthetic fibers embedded in a resin, the number and positioning of the plies being adapted to the load paths to which the composite repair patch is subjected once affixed on the composite profile.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic perspective view of a section of composite profile having a defect to which the teachings of the present disclosure are applied;

FIG. 2 is a sectional view according to the line II-II of FIG. 1 to which the teachings of the present disclosure are applied;

FIG. 3 is a schematic perspective view of a mold section containing a composite repair patch under production according to the present disclosure;

FIG. 4 is a sectional view according to the line IV-IV of FIG. 3; and

FIG. 5 is a sectional view similar to FIG. 2 after placing the composite repair patch according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

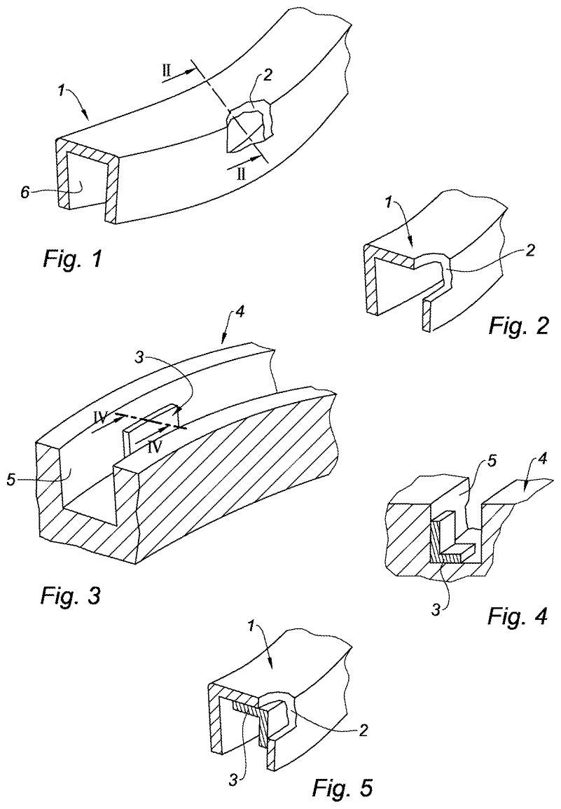

With reference to FIG. 1 to FIG. 5, the method according to the present disclosure is intended to provide the repair of a composite profile, here a bent U-shaped profile 1, including a defect, here a tear 2 (or delamination, or other damage to the U-shaped profile 1).

The U-shaped profile 1 is represented in the position it occupies when it is integrated into a structure (non-represented), for example an aircraft turbine engine support nacelle. The profile has a U-shaped configuration opening downwards and is curved about a vertical axis and about a horizontal axis.

According to the present disclosure, a composite repair patch 3 is produced by disposing an uncured composite repair composition, which includes plies embedded in an uncured resin, in a mold 4 having a configuration substantially identical to the configuration of the profile to be repaired. In this case, the mold 4 includes a groove 5 which has generally the same configuration as the inner surface 6 of the U-shaped profile 1 but which opens upwards. Under these conditions, the uncured (soft) composite repair composition conforms to the configuration of the groove 5, and after hardening, the composite repair patch 3 can be affixed in the U-shaped profile 1 as illustrated in FIG. 5. The composite repair patch 3 thus comprises plies of a fabric of fibers, which in one form may be synthetic fibers, embedded in a resin.

Alternatively, the uncured composite repair composition can be disposed directly on an identical area of the profile to be repaired. This profile is then fulfilling the mold function.

The placing of staged fabric plies, with respect to a metal reinforcement solution, allows further reducing extra stiffness with respect to a metal reinforcement solution.

Of course, the present disclosure is not limited to the described implementation mode and alternative forms can be made without departing from the scope of the present disclosure.

Particularly, although the present disclosure has been described in relation to a profile to be repaired having a U-shaped profile, it is applicable to any profile made of a composite material whose configuration does not allow direct access to the defect to be repaired, or whose geometry does not allow a conventional repair, or including a riveted reinforcement for improved mechanical strength.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for repairing a composite profile including a defect, the method comprising producing a composite repair patch by disposing an uncured composite repair composition in a mold having a configuration substantially identical to a corresponding configuration of the composite profile to be repaired, or on a substantially identical area of the composite profile to be repaired, hardening the uncured composite repair composition to form the composite repair patch, and affixing the composite repair patch obtained on the composite profile including the defect, wherein the composite repair patch comprises plies of a fabric of synthetic fibers embedded in a resin, a number and positioning of the plies being adapted to load paths to which the composite repair patch is subjected once affixed on the composite profile.
